(19) United States
(12) Patent Application Publication
(10) Pub. No.: US 2014/0267384 A1
(43) Pub. Date: Sep. 18, 2014

(54) DISPLAY APPARATUS AND CONTROL METHOD THEREOF

(71) Applicant: Samsung Electronics Co., Ltd., Gyeonggi-do (KR)

(72) Inventors: Oh-Yoon KWON, Daegu (KR); Kyu-Sung KIM, Seoul (KR)

(73) Assignee: Samsung Electronics Co., Ltd., Gyeonggi-do (KR)

(21) Appl. No.: 14/013,654

(22) Filed: Aug. 29, 2013

(30) Foreign Application Priority Data
Mar. 13, 2013 (KR) 10-2013-0026968

(51) Int. Cl. G06T 7/00

(52) U.S. Cl. CPC G06T 7/004
USPC 345/619

(57) ABSTRACT

A display apparatus for displaying at least one image and a control method thereof are provided. The control method includes storing the at least one image; determining an image arrangement condition for arranging the at least one image; arranging the at least one image and displaying the at least one arranged image under the image arrangement condition; and displaying an arrangement condition list including at least one index in the image arrangement condition.

### CLAIM OF PRIORITY

This application claims priority under 35 U.S.C. §119(a) to Korean Patent Application Serial No. 10-2013-0026968, which was filed in the Korean Intellectual Property Office on Mar. 13, 2013, the contents of which are incorporated herein by reference.

### BACKGROUND

1. Field of the Invention

The present disclosure relates to a display apparatus and a control method thereof, and more particularly, to a display apparatus capable of displaying at least one image and a control method thereof.

2. Description of the Related Art

A user of a desktop computer can divide a display screen for running multiple applications, e.g., a horizontal division or a vertical division in a case where the user performs a task while multiple windows are being displayed on the screen.

When a web browser is executed, the user can move in an upward direction or in a downward direction of web pages by using a page up button or a page down button included in a keyboard. When a mouse is used instead of the keyboard, the user can select a scroll bar provided at a side of a web page using a cursor to move in an upward direction or in a downward direction. Further, the user can select a “back to top” button which is represented by text or an icon and is located at a lower part of a web page to move to the uppermost part of the web page.

Meanwhile, a display unit displays an image on the entire screen. Before the display unit displays one particular image on the entire screen, it can display a list of images that it can display. The display unit of the prior art typically displays a list of the images, in the order of time points during which each of images is stored. As a result, when a user searches for a desired image, the user has to search through all images stored.

Therefore, when the image list is displayed, there is a need developing a technology which enables the user to more quickly search for a desired image.

### SUMMARY

Accordingly, the present invention has been made to address at least the above problems and/or disadvantages related to the prior art and to provide at least the advantages described below.

Aspects of the present invention provide a display apparatus which displays an image arrangement condition list and enables a quick search for an image, and a control method thereof.

In accordance with an aspect of the present invention, a control method of a display apparatus that displays at least one image includes storing the at least one image; selecting a specific image arrangement condition for arranging the at least one image; assigning the at least one image to the selected image arrangement condition; and displaying an arrangement condition list including at least one index corresponding to the selected image arrangement condition.

In accordance with another aspect of the present invention, a display apparatus includes a storage unit that stores at least one image; a display unit that displays the at least one image; and a controller controlling the display unit to select a specific image arrangement condition for arranging the at least one image, assign the at least one image to the selected the image arrangement condition in response to an input, and display an arrangement condition list including at least one index corresponding to the selected image arrangement condition.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram schematically illustrating a configuration of a display apparatus according to an embodiment of the present invention;

FIG. 2A is a flowchart illustrating a control method of a display apparatus according to an embodiment of the present invention;

FIG. 2B is a flowchart illustrating a control method of a display apparatus according to another embodiment of the present invention;

FIG. 2C is a flowchart illustrating a control method of a display apparatus according to still another embodiment of the present invention;

FIG. 2D is a flowchart illustrating a control method of a display apparatus according to yet another embodiment of the present invention;

FIGS. 3A, 3B, 3C and 3D are conceptual views of a display apparatus according to various embodiments of the present invention;

FIGS. 4A, 4B and 4C are conceptual views of a display apparatus according to another embodiment of the present invention;

FIGS. 5A and 5B are flowcharts illustrating a control method of a display apparatus according to an exemplary embodiment of the present invention;

FIGS. 5C, 5D and 5E are flowcharts illustrating a control method of a display apparatus according to another exemplary embodiment of the present invention;

FIGS. 6A, 6B and 6C are conceptual views of images displayed on a screen of a display apparatus according to various embodiments of the present invention;

FIGS. 7A and 7B are flowcharts illustrating a control method of a display apparatus according to an exemplary embodiment of the present invention;

FIGS. 8A, 8B and 8C are conceptual views of images displayed on a screen of a display apparatus according to various embodiments of the present invention;

FIGS. 9A and 9B are flowcharts illustrating a control method of a display apparatus according to an exemplary embodiment of the present invention;

FIGS. 10A, 10B and 10C are conceptual views of images displayed on a screen of a display apparatus according to various embodiments of the present invention;

FIGS. 11A and 11B are flowcharts illustrating a control method of a display apparatus according to an exemplary embodiment of the present invention; and

FIGS. 12A, 12B and 12C are conceptual views of images displayed on a screen of a display apparatus according to various embodiments of the present invention.

### DETAILED DESCRIPTION

Hereinafter, exemplary embodiments of the present invention will be described in detail with reference to the accompanying drawings. However, the present invention is not limited or restricted by exemplary embodiments thereof. Throughout the specification and drawings, an identical reference numeral denotes elements that all perform a substantially identical function.

FIG. 1 is a block diagram schematically illustrating a configuration of a display apparatus according to an embodiment of the present invention. Referring to FIG. 1, the display apparatus 100 may include a controller 110, a mobile communication module 120, a sub-communication module 130, a multimedia module 140, a camera module 150, a Global Positioning System (GPS) module 155, an input/output module 160, a sensor module 170, a storage unit 175, and a power supply unit 180, a touch screen or a display unit 190, and a touch screen controller 195, or any combination thereof.

According to exemplary embodiments of the present invention, a display apparatus 100 may be connected to an external device (not shown) by using a mobile communication module 120, a sub-communication module 130 and a connector 165. The external devices may be a mobile phone (not shown), a smart phone (not shown), a tablet PC (not shown), and a server (not shown).

According to an exemplary embodiment of the present invention, the sub-communication module 130 includes at least one of a wireless Local Area Network (LAN) module 131 and a short-range communication module 132 (e.g., an NFC communication module). For example, the sub-communication module 130 may include only the wireless LAN module 131, or may include only the short-range communication module 132. Alternatively, it may include both the wireless LAN module 131 and the short-range communication module 132.

According to an exemplary embodiment of the present invention, the multimedia module 140 includes at least one of a broadcasting communication module 141, an audio reproduction module 142, and a moving image reproduction module 143.

According to an exemplary embodiment of the present invention, the camera module 150 may include at least one of a first camera 151 and a second camera 152.

According to an exemplary embodiment of the present invention, the input/output module 160 includes at least one of buttons 161, a microphone 162, a speaker 163, a vibration motor 164, the connector 165 and a keypad 166.

The controller 110 may include a Central Processing Unit (CPU) 111, a Read-Only Memory (ROM) 112 which stores a control program for controlling the display apparatus 100, and a Random Access Memory (RAM) 113 which stores a signal or data received from the outside of the display apparatus 100, or which is used as a memory area for a task performed by the display apparatus 100. The CPU 111 may include multiple processors. For example, the CPU 111 may include a single-core processor, a dual-core processor, a triple-core processor, a quad-core processor, or the like. The CPU 111, the ROM 112 and the RAM 113 may be interconnected by an internal bus.

The controller 110 may control the mobile communication module 120, the sub-communication module 130, the multimedia module 140, the camera module 150, the GPS module 155, the input/output module 160, the sensor module 170, the storage unit 175, the power supply unit 180, a touch screen 190, and the touch screen controller 195.

According to the control of the controller 110, the mobile communication module 120 allows the display apparatus 100 to be connected to an external device through mobile communication by using at least one antenna or multiple antennas (not shown). The mobile communication module 120 transmits and receives a wireless signal for a voice call, a video call, a Short Message Service (SMS), a Multimedia Messaging Service (MMS), or the like to/from a mobile phone (not shown), a smart phone (not shown), a tablet PC or another device (not shown), which has a telephone number which is input to the display apparatus 100.

According to the control of the controller 110, the wireless LAN module 131 may be connected to the Internet at a place where a wireless Access Point (AP) (not shown) is installed. The wireless LAN module 131 supports a wireless LAN standard (e.g., IEEE 802.11x of the Institute of Electrical and Electronics Engineers (IEEE)). According to the control of the controller 110, the short-range communication module 132 enables the display apparatus 100 to perform short-range wireless communication with an image forming device (not shown). Short-range communication schemes may include Bluetooth, Infrared Data Association (IrDA), Zigbee, and the like.

According to the performance of the display apparatus 100, the display apparatus 100 may include at least one of the mobile communication module 120, the wireless LAN module 131 and the short-range communication module 132. For example, according to the performance of the display apparatus 100, the display apparatus 100 may include a combination of the mobile communication module 120, the wireless LAN module 131 and the short-range communication module 132.

The multimedia module 140 may include the broadcasting communication module 141, the audio reproduction module 142, or a moving image reproduction module 143. According to the control of the controller 110, the broadcasting communication module 141 may receive a broadcast signal (e.g., a TV broadcast signal, a radio broadcast signal, a data broadcast signal, and the like) and broadcast additional information (e.g., an Electronic Program Guide (EPS) or an Electronic Service Guide (ESG)), which are transmitted by a broadcast station through a broadcast communication antenna (not shown). According to the control of the controller 110, the audio reproduction module 142 may reproduce a stored or received digital audio file (e.g., a file having a file extension of mp3, wma, ogg, or way). According to the control of the controller 110, the moving image reproduction module 143 may reproduce a stored or received digital moving image file (e.g., a file having a file extension of mpeg, mpg, mp4, avi, mov, or mkv). The moving image reproduction module 143 may reproduce a digital audio file.

The multimedia module 140 may include the audio reproduction module 142 and the moving image reproduction module 143, except for the broadcasting communication module 141. Also, the audio reproduction module 142 or the moving image reproduction module 143 of the multimedia module 140 may be included in the controller 110.

The camera module 150 may include at least one of the first camera 151 and the second camera 152, each for capturing a still image or a moving image according to the control of the controller 110. Also, the first camera 151 or the second camera 152 may include an auxiliary light source, such as a flash (not shown), which provides the amount of light required to capture an image. The first camera 151 may be mounted on a front surface of the display apparatus 100, and the second camera 152 may be mounted on a rear surface of the display apparatus 100. Otherwise, the first camera 151 and the second camera 152 may be disposed in such a manner as to be adjacent to each other (e.g., a distance between the first camera 151 and the second camera 152 is greater than 1 cm and is less than 8 cm), and may capture a three-dimensional still image or a three-dimensional moving image.

The GPS module 155 may receive a signal (e.g., a radio wave) from each of multiple GPS satellites (not shown) in the Earth's orbit, and may calculate a location of the display apparatus 100 by using a Time of Arrival (TOA) from each of the GPS satellites (not shown) to the display apparatus 100.

The input/output module 160 may include at least one of the multiple buttons 161, the microphone 162, the speaker 163, the vibration motor 164, the connector 165 and the keypad 166.

The buttons 161 may be formed on a front surface, a lateral surface or a rear surface of a housing of the display apparatus 100, and may include at least one of a power/lock button (not shown), a volume button (not shown), a menu button, a home button, a back button and a search button.

According to the control of the controller 110, the microphone 162 may receive a voice or sound as input, and may generate an electrical signal.

According to the control of the controller 110, the speaker 163 may output sounds matched to various signals (e.g., a wireless signal, a broadcast signal, a digital audio file, a digital moving image file, and photographing) from the mobile communication module 120, the sub-communication module 130, the multimedia module 140 and the camera module 150, to the outside of the display apparatus 100. The speaker 163 may output a sound (e.g., a button operation sound or a ring back tone matched to a telephone call) matched to a function that the display apparatus 100 performs. The display apparatus 100 may include multiple speakers. The speaker 163 or multiple speakers may be disposed at an appropriate position or appropriate positions of the housing of the display apparatus 100.

According to the control of the controller 110, the vibration motor 164 may convert an electrical signal into a mechanical vibration. For example, when the display apparatus 100 in a vibration mode receives a voice call from another device (not shown), the vibration motor 164 of the display apparatus 100 operates. The display apparatus 100 may include multiple vibration motors. The vibration motor 164 or multiple vibration motors may be mounted within the housing of the display apparatus 100. The vibration motor 164 may operate in response to a touch action of a user who touches the touch screen 190 and a continuous movement of a touch on the touch screen 190.

The connector 165 may be used as an interface for connecting the display apparatus 100 to an external device (not shown) or a power source (not shown). According to the control of the controller 110, through a wired cable connected to the connector 165, the display apparatus 100 may transmit data stored in the storage unit 175 of the display apparatus 100 to an external device (not shown) or may receive data from the external device (not shown). Also, through the wired cable connected to the connector 165, the display apparatus 100 may be supplied with power from the power source (not shown) or may charge a battery (not shown) by using the power source.

The keypad 166 may receive key input from the user in order to control the display apparatus 100. The keypad 166 includes a physical keypad (not shown) installed on the front surface of the display apparatus 100 or a virtual keypad (not shown) displayed on the touch screen 190. The physical keypad (not shown) installed on the front surface of the display apparatus 100 may be excluded according to the performance or structure of the display apparatus 100.

The sensor module 170 includes at least one sensor for detecting the state of the display apparatus 100. For example, the sensor module 170 may include a proximity sensor for detecting whether the user is close to the display apparatus 100, an illuminance sensor (not shown) for detecting the amount of light around the display apparatus 100, a motion sensor (not shown) for detecting the motion of the display apparatus 100 (e.g., the rotation of the display apparatus 100, or acceleration or vibration applied to the display apparatus 100), and the like. At least one sensor may detect the state of the display apparatus 100, may generate a signal matched to the detection, and may transmit the generated signal to the controller 110. According to the performance of the display apparatus 100, sensors may be added to or removed from the sensor module 170.

According to the control of the controller 110, the storage unit 175 may store a signal or data which is input/output in response to an operation of each of the mobile communication module 120, the sub-communication module 130, the multimedia module 140, the camera module 150, the GPS module 155, the input/output module 160, the sensor module 170, and the touch screen 190. The storage unit 175 may store a control program for controlling the display apparatus 100 or a control program for the controller 110, and applications.

The term “storage unit” includes the storage unit 175, the ROM 112 and the RAM 113 within the controller 110, or a memory card (not shown), such as a Secure Digital (SD) card or a memory stick, which is mounted on the display apparatus 100. The storage unit may include a non-volatile memory, a volatile memory, a Hard Disk Drive (HDD), a Solid State Drive (SSD), and the like.

According to the control of the controller 110, the power supply unit 180 may supply power to one battery or multiple batteries (not shown) disposed in the housing of the display apparatus 100 which in turn supply power to the display apparatus 100. Also, the power supply unit 180 may supply power provided by an external power source (not shown) to the display apparatus 100 through a wired cable connected to the connector 165.

The touch screen 190 may provide the user with a user interface matched to various services (e.g., telephone call, data transmission, broadcasting, and photography). The touch screen 190 may transmit an analog signal matched to at least one touch, which is input to the user interface, to the touch screen controller 195. The touch screen 190 may receive at least one touch as input from the user's body (e.g., fingers, thumbs, and the like) or an input means (e.g., a stylus pen) enabling a touch. Also, the touch screen 190 may receive, as input, a continuous movement of one touch with respect to at least one touch. The touch screen 190 may transmit an analog signal matched to a continuous movement of an input touch, to the touch screen controller 195.

According to exemplary embodiments of the present invention, a touch is not limited to the touch of the user's body or the input means enabling a touch on the touch screen 190, but may also include a non-contact touch (e.g., a detectable distance between the touch screen 190 and the user's body or the input means enabling a touch is less than or equal to 1 mm). In the touch screen 190, a detectable distance may change depending on the performance or structure of the display apparatus 100.

The touch screen 190, for example, may be implemented as a resistive touch screen, a capacitive touch screen, an infrared touch screen, an Electromagnetic Resonance (EMR) touch screen, an acoustic wave touch screen, and/or the like.

The touch screen controller 195 converts an analog signal received from the touch screen 190 into a digital signal (e.g., X and Y coordinates), and provides the digital signal to the controller 110. The controller 110 may control the touch screen 190 by using the digital signal received from the touch screen controller 195. For example, in response to a touch, the controller 110 may perform a control operation so as to select or execute a shortcut icon (not shown) displayed on the touch screen 190. Also, the touch screen controller 195 may be included in the controller 110.

FIG. 2A is a flowchart illustrating a control operation of a display apparatus according to an embodiment of the present invention. The control method illustrated in FIG. 2A will be described in more detail below with reference to FIGS. 3A to 3D. FIGS. 3A to 3D are conceptual views of a display apparatus according to various embodiments of the present invention.

The display apparatus 100 may store at least one image, which it intends to display, in the storage unit 175 in step S201. The display apparatus 100 may determine an image arrangement condition, as shown in FIG. 3A, related to a method for arranging the at least one image stored in the storage unit 175, in step S203. The display apparatus 100 may receive an image arrangement condition selection externally, or the display apparatus 100 may arrange images by using a default image arrangement condition.

FIG. 3A is a conceptual view of a display apparatus according to an embodiment of the present invention. Referring to FIG. 3A, the controller 110 may control the touch screen 190 to display a user interface screen 300 enabling the selection of an image arrangement condition. Here, the user interface screen 300 enabling the selection of an image arrangement condition which includes the selection of a first condition 311, a second condition 312, a third condition 313, or a fourth condition 314. Here, the image arrangement condition may be classified according a color, an image-capturing time point, an image-capturing place, the name of a person in an image, or the like, as further explained in details later. Also, the user interface screen 300 may further include selection windows 301, 302, 303 and 304 enabling the selection of any one of the first condition 311 to the fourth condition 314. Moreover, more than two conditions can be selected among a first condition to a fourth condition. For example, in case that condition for colors and name and condition for colors and weather are selected, it can be arranged according to the corresponding to the conditions. In operation, for example, a user may select the second condition 312 as an image arrangement condition. The controller 110 performs a control operation for displaying the second condition 312 in the second selection window 302, in order to enable the user to recognize that the second condition 312 has been selected.

Referring back to FIG. 2A, the controller 110 may perform a control operation for arranging images under the determined arrangement condition and displaying the arranged images, in step S205. Further, the controller 110 may perform a control operation for displaying an arrangement condition list depending on the determined arrangement condition together with the arranged images, in step S207. Here, the arrangement condition list may include at least one arrangement condition index. The arrangement condition index may be an index capable of indicating the order of arranging images under the relevant arrangement condition. A relation between an arrangement condition and an arrangement condition index corresponding to the arrangement condition, for example, may be as shown in Table 1 below.

TABLE 1

| Arrangement condition | Arrangement condition index |
|---|---|
| Image color | R, G and B color values |
| Image-capturing time point | Day, month and year when image has |
| | been captured |
| Image-capturing place | Letter of alphabet representing |
| | consonant as initial sound of name of |
| | place where image has been captured |
| Captured person in image | Letter of alphabet representing |
| | consonant as initial sound of name of |
| | captured person in an image |

When an image color is determined as an arrangement condition, the controller 110 may perform a control operation for arranging images in a preset color order and also displaying the preset color order together with the arranged images. Particularly, the controller 110 may perform a control operation for displaying a bar representing the preset color order together (not shown). Note that the arrangement conditions and arrangement condition indexes as described above will be described in more detail below.

FIG. 3B is a conceptual view of a display apparatus according to an embodiment of the present invention. The controller 110 may perform a control operation for displaying an A image 321, a B image 322, a C image 323, a D image 324, an E image 325 and an F image 326 on the touch screen 190. Particularly, the controller 110 may perform a control operation for arranging the A image 321 to the F image 326 under the second arrangement condition determined as illustrated in FIG. 3A. Specifically, the A image 321 to the F image 326 are images arranged under the second arrangement condition. Also, the controller 110 may perform a control operation for displaying indexes 331 to 335 related to the second arrangement condition together. The first index 331 to the n-th index 335 may be indexes capable of indicating the order of arranging images under the second arrangement condition. For example, the A image 321 to the D image 324 may correspond to the first index 331. Also, the E image 325 and the F image 326 may correspond to the second index 332.

As shown in FIG. 3B, the controller 110 may perform a control operation for displaying the A image 321 corresponding to the first index 331 on an uppermost part of the touch screen 190, and may perform a control operation for placing and displaying the B image 322 to the F image 326 arranged under the second arrangement condition below the A image 321 on the touch screen 190.

FIG. 2B is a flowchart illustrating a control method of a display apparatus according to another embodiment of the present invention.

Referring to FIG. 2B, the controller 110 may perform a control operation for displaying at least one image arranged under an arrangement condition and an arrangement condition list together, in step S211. Here, the arrangement condition list may include at least one index as described with reference to FIG. 3B above.

The user may designate one index in the displayed arrangement condition list, in step S213. For example, a user 1 may designate a third index 333 as illustrated in FIG. 3C. In an exemplary embodiment of the present invention as illustrated in FIG. 3C, the user 1 may input a gesture touching the third index 333, and thereby may designate that particular index.

Referring again to FIG. 2B, the controller 110 may perform a control operation for displaying an image corresponding to the designated index, in step S215. Otherwise, as illustrated in FIG. 2C, the controller 110 may perform a control operation for displaying the image corresponding to the designated index and images arranged adjacently to the relevant image together, in step S217.

For example, referring to FIG. 3D, the controller 110 may perform a control operation for displaying a J image 341 corresponding to the third index 333 on the uppermost part of the touch screen 190. In FIG. 3D, it is presumed that the J image 341 to an O image 346 correspond to the third index 333. The controller 110 may perform a control operation for placing and displaying the K image 342 to the O image 346 arranged under the second arrangement condition below the J image 341 on the touch screen 190.

As described above, the display apparatus 100 according to exemplary embodiments of the present invention may designate an index, and thereby may quickly display an image corresponding to the relevant index. Accordingly, an image that the user desires can be quickly identified through manipulation of index icons. Also, images are arranged under each of the various arrangement conditions and stored accordingly, so that the user can easily search for an image group that the user desires from the classification of various arrangement conditions.

FIG. 2D is a flowchart illustrating a control method of a display apparatus according to an embodiment of the present invention.

Referring to FIG. 2D, the display apparatus 100 may store at least one image in step S221. When the at least one image is stored, the controller 110 may analyze metadata of the at least one image, in step S223. For example, the controller 110 may identify various metadata, such as a representative color of an image, an image-capturing time point, the name of an image-capturing place, and the name of a captured person in an image.

When the camera module 150 captures an image and stores the captured image in the storage unit 175, the controller 110 may generate metadata and may store the generated metadata together with the captured image. For example, the controller 110 may identify a time point when the image has been captured, and may store the time point as metadata. The controller 110 may receive, as input, GPS coordinates of a place where the image has been captured, from the GPS module 155, and may store a place name corresponding to the GPS coordinates, as metadata. The controller 110 may perform face recognition on a captured person in the image, and may store the name of the person obtained from a result of performing the face recognition, as metadata. The controller 110 may identify a color (i.e., a representative color) which is widely distributed in the captured image, and may store the identified representative color as metadata. The controller 110 may generate metadata including at least one of the time point when the image has been captured, the place where the image has been captured, the person information and the representative color, as described above, and may store the generated metadata together with the image.

Otherwise, the controller 110, for example, may receive an image from another apparatus, and may analyze metadata included in the received image.

The controller 110 may arrange images and may display the arranged images, based on the arrangement condition and the metadata, in step S225. More specifically, the controller 110 may arrange the metadata based on the arrangement condition. For example, when an arrangement condition is an image-capturing place, the controller 110 may arrange the identified metadata (i.e., names of image-capturing places) in alphabetical order. The controller 110 may perform a control operation for arranging images in such a manner as to correspond to the arranged metadata, and displaying the arranged images.

The controller 110 may perform a control operation for displaying an arrangement condition list depending on the determined arrangement condition together with the arranged images, in step S227.

FIGS. 4A to 4C are conceptual views of a display apparatus according to another embodiment of the present invention.

Referring to FIG. 4A, the display apparatus 100 may display a gallery application on the touch screen 190. In FIGS. 4A to 4C, the touch screen 190 displays an A image 401 to an O image 415. A corresponding relation between the A image 401 to the O image 415 and indexes may be as shown in Table 2 below.

TABLE 2

| Index | Image |
|---|---|
| First index | A~D images |
| Second index | E~I images |
| Third index | J~O images |

As illustrated in FIG. 4A, the controller 110 may perform a control operation for displaying the A image 401 corresponding to the first index on the uppermost part of the touch screen 190. Also, the controller 110 may perform a control operation for placing and displaying the B image 402 to the F image 406 arranged under the relevant arrangement condition below the A image 401 on the touch screen 190.

The controller 110 may perform a control operation for displaying an index display bar 441, which correspond to the first index to the n-th index, and an indicator 442 together. The controller 110 may perform a control operation for displaying the A image 401 corresponding to an index (i.e., the first index in FIG. 4A) indicated by the indicator 442 on the uppermost part of the touch screen 190.

Meanwhile, the user may input a drag gesture which drags the indicator 442, and thereby may operate the indicator 442 in such a manner as to change a position of the indicator 442. The controller 110 may perform a control operation for moving the indicator 442 to an end point of the input drag gesture and displaying the moved indicator 442.

For example, the user may input a drag gesture from a current position of the indicator 442 to a position corresponding to the second index. In response to the input drag gesture, as illustrated in FIG. 4B, the controller 110 may perform a control operation for moving the indicator 442 to a position corresponding to the second index, and displaying the moved indicator 442. Also, the controller 110 may perform a control operation for displaying the E image 405 corresponding to the second index on the uppermost part of the touch screen 190. Also, the controller 110 may perform a control operation for placing and displaying the F image 406 to the J image 410 arranged under the relevant arrangement condition below the E image 405 on the touch screen 190.

Also, the user may input a drag gesture from a current position of the indicator 442 to a position corresponding to the third index. In response to the input drag gesture, as illustrated in FIG. 4C, the controller 110 may perform a control operation for moving the indicator 442 to a position corresponding to the third index, and displaying the moved indicator 442. Also, the controller 110 may perform a control operation for displaying the J image 410 corresponding to the third index on the uppermost part of the touch screen 190. Also, the controller 110 may perform a control operation for placing and displaying the K image 411 to the O image 415 arranged under the relevant arrangement condition below the J image 410 on the touch screen 190.

As described above, the display apparatus 100 may provide user interfaces of various schemes, and may receive an index designated through a selection of each of the user interfaces.

Hereinafter, arrangements of images under various arrangement conditions will be described. First, a case where an arrangement condition is a color of an image, will be described below.

FIGS. 5A and 5B are flowcharts illustrating a control method according to an exemplary embodiment of the present invention. The control method illustrated in FIGS. 5A and 5B will be described with reference to FIGS. 6A to 6C. FIGS. 6A to 6C are conceptual views of images displayed on a screen of a display apparatus according to various embodiments of the present invention.

The display apparatus 100 may store at least one image in step S501. Then, the display apparatus 100 may determine that an arrangement condition is a color of an image, in step S503. To this end, a display apparatus 100 may receive, as input, a color of an image as an arrangement condition. Otherwise, the display apparatus 100 may determine that a default arrangement condition is a color of an image.

The controller 110 may determine which color is a representative color of the at least one stored image, in step S505. A configuration such that the controller 110 determines which color is a representative color of an image will be described in more detail below with reference to FIGS. 5C to 5E.

The controller 110 may arrange the at least one image and may display the at least one image, based on the preset color arrangement condition and the representative color of the at least one stored image. Here, the preset color arrangement condition, for example, may be the order of red, orange, yellow, green, blue, indigo, violet and black. More specifically, a preset color arrangement condition may be as shown in Table 3 below.

TABLE 3

| Order | R value of RGB | G value of RGB | B value of RGB |
|---|---|---|---|
| 1 | 255 | 0 | 0~255 |
| 2 | 255 | 0~255 | 0 |
| 3 | 0~255 | 255 | 0 |
| 4 | 0 | 255 | 0~255 |
| 5 | 0 | 0~255 | 255 |
| 6 | 0~255 | 0 | 255 |
| 7 | 0~255 | 0~255 | 0~255 |

The controller 110 may arrange images under the preset color arrangement condition as shown in Table 3, and may display the arranged images, in step S507. Also, the controller 110 may perform a control operation for displaying the preset color arrangement condition together with the arranged images, in step S509.

As illustrated in FIG. 6A, the controller 110, for example, may perform a control operation for displaying images 611 to 634 arranged according to the order of classification of the preset color arrangement condition as shown in Table 3. Particularly, the controller 110 may perform a control operation for displaying the arranged images 611 to 634 in the form of a spiral. More specifically, the controller 110 may perform a control operation for first displaying the arranged first image 611 at the uppermost part of the touch screen 190. The controller 110 may perform a control operation for placing and displaying the second image 612 on the lower left side of the first image 611. Also, the controller 110 may perform a control operation for placing and displaying the third image 613 on the lower left side of the second image 612. Particularly, the controller 110 may perform a control operation for displaying the second image 612 and the third image 613 in such a manner as to cover the third image 613 with the second image 612. Meanwhile, it may be identified that the third image 613 is displayed on a left end part of the relevant screen. Accordingly, the controller 110 may perform a control operation for placing and displaying the fourth image 614 on the lower right side of the third image 613. Also, the controller 110 may perform a control operation for placing and displaying the fifth image 615 on the lower right side of the fourth image 614, thus forming a spiral form. Meanwhile, when images are displayed from the first image 611 to the fifth image 615, the controller 110 may perform a control operation for displaying the first image 611 to the fifth image 615 in such a manner as to gradually reduce sizes of the first image 611 to the fifth image 615.

As above, the display apparatus 100 can produce a depth effect such that the following image seems to be placed relatively after the previous one in a direction from the first image 611 to the fifth image 615. Similarly, the controller 110 may perform a control operation for placing and displaying the sixth image 616 on the lower right side of the fifth image 615. Further, the controller 110 may perform a control operation for placing and displaying the seventh image 617 on the lower right side of the sixth image 616. Meanwhile, it may be identified that the seventh image 617 is displayed on a right end part of

the relevant screen. Accordingly, the controller 110 may perform a control operation for placing and displaying the eighth image 618 on the lower left side of the seventh image 617. The controller 110 may perform a control operation for placing and displaying the ninth image 619 on the lower left side of the eighth image 618. Meanwhile, when images are displayed from the fifth image 615 to the ninth image 619, the controller 110 may perform a control operation for displaying the fifth image 615 to the ninth image 619 in such a manner as to gradually increase sizes of the fifth image 615 to the ninth image 619. Accordingly, the display apparatus 100 can produce an effect such that the following image seems to be placed relatively before the previous one in a direction from the fifth image 615 to the ninth image 619. As described above, the display apparatus 100 may display the first image 611 to the ninth image 619 in such a manner that the first image 611 to the ninth image 619 seem to be placed in the form of a spiral. Meanwhile, the controller 110 may perform a control operation for repeatedly placing the ninth image 619 to the 24-th image 634 as described above.

The controller 110 may perform a control operation for displaying (as denoted by reference numeral 601) that an arrangement condition is a color order. Also, the controller 110 may perform a control operation for displaying the preset color arrangement condition 690 in the form of a bar.

FIG. 5B is a flowchart illustrating a control method according to another embodiment of the present invention.

The display apparatus 100 may display a preset color arrangement condition and arranged images together on the touch screen 190, in step S511. Meanwhile, a user may designate a first color of the preset color arrangement condition displayed on the touch screen 190, in step S513. For example, as shown in FIG. 6B, the user may designate or point to a first color 691 on a color arrangement condition bar 690.

In response, the controller 110 may display a first image corresponding to the first color 691, in step S515. The controller 110 may perform a control operation for displaying a 40th image 650 corresponding to the first color 691 in the center of the relevant screen. For example, when the user designates a blue index of the preset color arrangement condition, the controller 110 may perform a control operation for displaying an image having a representative color of blue in the center of the relevant screen. Also, the controller 110 may perform a control operation for displaying images 641 to 649 and 651 to 665 adjacent to the 40th image 650, together with the 40th image 650.

When the user stop touching of the 40th image 650, the controller 110 may perform a control operation for confirming a screen and displaying the screen as illustrated in FIG. 6C.

Hereinafter, a method of determining a representative color of an image and arranges images for each color will be described with reference to FIGS. 5C to 5E.

Referring to FIG. 5C, the controller 110 may acquire RGB values of each pixel of a stored image, in step S521. More specifically, the controller 110 may identify RGB values of each of all pixels in the stored image. The controller 110 may generate statistics on the RGB values, and may determine RGB values of a maximum number of pixels, in step S523. The controller 110 may determine that a representative color is the determined RGB values of a maximum number of pixels, in step S525.

FIG. 5D and FIG. 5E are detailed flowcharts illustrating a method for arranging images for each color according to another exemplary embodiment of the present invention.

FIG. 5D is a flowchart illustrating a method for acquiring values of a color histogram during storage of an image in a display apparatus according to exemplary embodiments of the present invention. First, when an image has been captured, the controller 110 acquires values of Red (R), Green (G) and Blue (B) from each pixel of the captured image and identifies the total number of pixels depending on a resolution of the captured image, in step S531. For example, when a resolution of the captured image is equal to 48×80, the controller 110 may identify that the total number of pixels in the captured image is equal to 3,840.

Then, the controller 110 generates a histogram having a preset number (e.g., n) of bins for each color by using the acquired R, G and B values of each pixel, in step S533. Here, a range of the bin changes depending on an RGB format. For example, when the preset number of bins is equal to 8 in an RGB 888 format in which the number of bits of each of R, G and B values is equal to 8 (i.e., the total number of values of each of R, G and B is equal to 256), it is possible to generate a histogram (or a histogram vector) in which a bin of each of R, G and B has a range of 32.

When the histogram is generated, the total number of pixels changes depending on a resolution in each captured image. Accordingly, the controller 110 divides values of the generated histogram of R, G and B by the identified total number of pixels and thereby calculates values of a normalized color histogram vector, in step S535.

For example, when a resolution of the captured image is equal to 48×80 and the total number of pixels in the captured image is equal to 3,840, the controller 110 divides values of the generated histogram of R, G and B by 3,840, and thereby calculates values of a normalized color histogram vector.

Then, the controller 110 encodes the captured image in step S537. In step S539, the controller 110 stores the values of the color histogram vector normalized by using the color information of the image, together with the encoded image, in a file system.

FIG. 5E is a flowchart illustrating a method for arranging images when an arrangement condition is a color. More specifically, FIG. 5E is a flowchart illustrating a method for arranging images by using a color histogram in a display apparatus according to exemplary embodiments of the present invention.

When it is determined that an arrangement condition is a color of an image, the controller 110 identifies values of a color histogram vector of each image, in step S541. After the controller 110 identifies the values of the color histogram vector of each image, it arranges images, which have similar values between color histogram vectors thereof, adjacently to each other and then displays the arranged images, in step S543.

As described above, when the arrangement condition is a color, the display apparatus 100 may arrange images having similar colors adjacently to each other, and may display the arranged images as described above. As a result, when the user intends to quickly search for a particular color, the user may designate a desired color of a color arrangement condition displayed in the form of a bar, and may quickly identify images having the particular color.

FIGS. 7A and 7B are flowcharts illustrating a control method according to an exemplary embodiment of the present invention. The control method illustrated in FIGS. 7A and 7B will be described with reference to FIGS. 8A to 8C. FIGS. 8A to 8C are conceptual views of images displayed on a screen of a display apparatus according to various embodiments of the present invention.

The display apparatus 100 may store at least one image in step S701. The display apparatus 100 may determine that an image arrangement condition is the name of a person in an image, in step S703. For example, the display apparatus 100 may receive, as input, the name of a person in an image, as the image arrangement condition. Otherwise, the display apparatus 100 may determine that a default image arrangement condition is the name of a person in an image.

The controller 110 may determine the name of a person in at least one stored image, in step S705. To this end, the controller 110 may apply a face recognition algorithm to at least one stored image. Recognizing a person can be performed in a number of ways known to those skilled in this art. For example, the controller 110 may recognize a person in at least one stored image by applying various face recognition algorithms, such as principal component analysis, linear discriminate analysis, elastic bunch graph matching, hidden markov model, multilinear subspace learning and neuronal motivated dynamic link matching, to the at least one stored image. The controller 110 may match the recognized person with pre-stored names, and thereby may determine the name of the person in the at least one stored image.

Thereafter, the controller 110 may arrange the at least one image and may display the at least one arranged image, based on an alphabetical index and the name of the person in the at least one stored image. Here, an alphabetical order may be determined as the order of consonants of Hangul and/or an English alphabetical order. However, this configuration is described for illustrative purposes only. Accordingly, those skilled in the art will easily understand that there is no restriction on the alphabetical order.

The controller 110 may arrange the at least one image in alphabetical order, and may display the at least one arranged image, in step S707. Also, the controller 110 may perform a control operation for displaying a person name list together with the at least one arranged image, in step S709. Here, the person name list may include names of the recognized persons, or may include an alphabet, such as Hangul or the English alphabet.

The controller 110, for example, may perform a control operation for displaying images 811 to 834 arranged in alphabetical order as illustrated in FIG. 8A. Particularly, the controller 110 may perform a control operation for displaying the arranged images 811 to 834 in the form of a spiral.

The controller 110 may perform a control operation for displaying that an arrangement condition is a name (as denoted by reference numeral 801). Also, the controller 110 may perform a control operation for displaying a preset person name list 890 in the form of a bar. In an exemplary embodiment of the present invention as illustrated in FIG. 8A, the person name list 890 includes the English alphabet.

FIG. 7B is a flowchart illustrating a control method of a display apparatus according to another embodiment of the present invention.

The display apparatus 100 may display a person name list and arranged images together on the touch screen 190, in step S711. Meanwhile, the user may designate a first index in the person name list displayed on the touch screen 190, in step S713. For example, the user may designate a first index 891 in the person name list 890, as illustrated in FIG. 8B.

The controller 110 may display a first image corresponding to the first index 891, in step S715. The controller 110 may perform a control operation for displaying a 40th image 850 corresponding to the first index 891 in the center of the relevant screen. Also, the controller 110 may perform a control operation for displaying images 841 to 849 and 851 to 865 adjacent to the 40th image 850, together with the 40th image 850. For example, when the user designates an M index, in FIG. 8B, the controller 110 may perform a control operation for displaying an image including a person having a name starting with “M” in the center of the relevant screen.

When the user releases his/her touch of the 40th image 850, the controller 110 may perform a control operation for confirming a screen and displaying the defined screen as illustrated in FIG. 8C.

FIGS. 9A and 9B are flowcharts illustrating a control method of a display apparatus according to an exemplary embodiment of the present invention. The control method illustrated in FIGS. 9A and 9B will be described with reference to FIGS. 10A to 10C. FIGS. 10A to 10C are conceptual views of images displayed on a screen of a display apparatus according to various embodiments of the present invention.

The display apparatus 100 may store at least one image in step S901. The display apparatus 100 may determine that an arrangement condition is a time point when an image has been captured, in step S903. For example, the display apparatus 100 may receive, as input, a time point when an image has been captured, as an arrangement condition. The time point may be included, for example, in metadata of the image. Otherwise, the display apparatus 100 may determine that a default arrangement condition is a time point when an image has been captured.

The controller 110 may determine a time point when at least one stored image has been captured, in step S905. When an image is captured, the controller 110 may store an image-capturing time point together with the captured image.

The controller 110 may arrange at least one image and may display the at least one arranged image, based on a time table and a time point when an image has been captured. Here, the time table may be determined in the order of second, minute, hour, day, month and year. The controller 110 may arrange at least one image based on a time point when the at least one image has been captured, and may display the at least one arranged image, in step S907. Also, the controller 110 may perform a control operation for displaying the time table together with the at least one arranged image, in step S909.

The controller 110, for example, may perform a control operation for displaying images 1011 to 1034 arranged based on an image-capturing time point, as illustrated in FIG. 10A. Particularly, the controller 110 may perform a control operation for displaying the arranged images 1011 to 1034 in the form of a spiral.

The controller 110 may perform a control operation for displaying that the arrangement condition is an image-capturing time point (as denoted by reference numeral 1001). Also, a controller 110 may perform a control operation for displaying a time table 1090 in the form of a bar. In an exemplary embodiment of the present invention as illustrated in FIG. 10A, the time table 1090 includes numbers, such as 1 to 9.

FIG. 9B is a flowchart illustrating a control method of a display apparatus according to another embodiment of the present invention.

The display apparatus 100 may display a time table and arranged images together on the touch screen 190, in step S911. Meanwhile, the user may designate a first index in the time table displayed on the touch screen 190, in step S913. For example, the user may designate a first index 1091 in the time table 1090, as illustrated in FIG. 10B.

The controller 110 may display a first image corresponding to the first index 1091, in step S915. The controller 110 may perform a control operation for displaying a 40th image 1050 corresponding to the first index 1091 in the center of the relevant screen. Also, the controller 110 may perform a control operation for displaying images 1041 to 1049 and 1051 to 1065 adjacent to the 40th image 1050, together with the 40th image 1050. For example, when the user designates September 2012, the controller 110 may perform a control operation for displaying an image captured in September, 2012 in the center of the relevant screen.

When the user releases touch of the 40th image 1050, the controller 110 may perform a control operation for confirming a screen and displaying the defined screen as illustrated in FIG. 10C. In this case image 1050 is indicated by the icon shown. FIGS. 11A and 11B are flowcharts illustrating a control method of a display apparatus according to an exemplary embodiment of the present invention. The control method illustrated in FIGS. 11A and 11B will be described with reference to FIGS. 12A to 12C. FIGS. 12A to 12C are conceptual views of images displayed on a screen of a display apparatus according to various embodiments of the present invention.

The display apparatus 100 may store at least one image in step S 1101. The display apparatus 100 may determine that an arrangement condition is a place where an image has been captured, in step S 1103. For example, a display apparatus 100 may receive, as input, a place where an image has been captured, as an arrangement condition. Otherwise, the display apparatus 100 may determine that a default arrangement condition is a place where an image has been captured.

The controller 110 may determine a place where the at least one stored image has been captured, in step S1105. When an image is captured, the controller 110 may store GPS coordinate values together with the captured image. The controller 110 may identify the GPS coordinate values, may match the identified GPS coordinate values with a place name database, and may determine a place where the image has been captured.

The controller 110 may arrange the at least one image and may display the at least one arranged image, based on an alphabetical index and the place where the at least one image has been captured. Here, an alphabetical order may be determined as the order of consonants of Hangul and/or an English alphabetical order. However, this configuration is described for illustrative purposes only. Accordingly, those skilled in the art will easily understand that there is no restriction on the alphabetical order.

The controller 110 may arrange the at least one image and may display the at least one arranged image, in alphabetical order based on the name of the place where the at least one image has been captured, in step S 1107. Also, the controller 110 may perform a control operation for displaying a place name list together with the at least one arranged image, in step S 1109. Here, the place name list may include the name of a place where an image has been captured, or may include an alphabet.

The controller 110, for example, may perform a control operation for displaying images 1211 to 1234 arranged in alphabetical order as illustrated in FIG. 12A. Particularly, the controller 110 may perform a control operation for displaying the arranged images 1211 to 1234 in the form of a spiral.

The controller 110 may perform a control operation for displaying that an arrangement condition is a place name (as denoted by reference numeral 1201). Also, the controller 110 may perform a control operation for displaying a preset place name list 1290 in the form of a bar. In an exemplary embodiment of the present invention as illustrated in FIG. 12A, the place name list 1290 includes the English alphabet.

FIG. 11B is a flowchart illustrating a control method of a display apparatus according to another embodiment of the present invention.

The display apparatus 100 may display a place name list and arranged images together on the touch screen 190, in step S1111. Meanwhile, the user may designate a first index in the place name list displayed on the touch screen 190, in step S 1113. For example, the user may designate a first index 1291 in the place name list 1290, as illustrated in FIG. 12B.

The controller 110 may display a first image corresponding to the first index 1291, in step S 1115. The controller 110 may perform a control operation for displaying a 40th image 1250 corresponding to the first index 1291 in the center of the relevant screen. Also, a controller 110 may perform a control operation for displaying images 1241 to 1249 and 1251 to 1265 adjacent to the 40th image 1250, together with the 40th image 1250. For example, when the user designates an M index, the controller 110 may perform a control operation for displaying an image corresponding to a place name starting with “M” in the center of the relevant screen.

When the user stop touching of the 40th image 1250, the controller 110 may perform a control operation for confirming a screen and displaying the defined screen as illustrated in FIG. 12C.

Having thus described, it will be apparent to those skilled in the art that certain advantages can be obtained according to the teachings of the present invention where a display of an image arrangement condition list enables a quick search for a desired image by allowing the images to be classified and stored according to predetermined criteria described above for an easier access later.

It will be appreciated that the exemplary embodiments of the present invention may be implemented in the form of hardware, software, or a combination of hardware and software. Any such software may be stored in a volatile or non-volatile storage device such as a ROM, or in a memory such as a RAM, a memory chip, a memory device or a memory integrated circuit, or in a storage medium, such as a Compact Disc (CD), a Digital Versatile Disc (DVD), a magnetic disk or a magnetic tape, which is optically or magnetically recordable and simultaneously, is readable by a machine (e.g., a computer), regardless of whether the software can be deleted or rewritten. It will be appreciated that the control method of the display apparatus for displaying an image according to exemplary embodiments of the present invention may be implemented by a computer or a portable terminal including a controller and a memory, and that the memory is an example of a non-transient machine-readable storage medium suitable for storing a program or programs including instructions for implementing the exemplary embodiments of the present invention. Accordingly, exemplary embodiments of the present invention include a program including codes for implementing an apparatus or a method which is claimed in any claim of this specification, and a storage medium which stores this program and is readable by a machine (e.g., a computer).

Also, the display apparatus may receive and store the program from a device for providing a program, which is connected to the display apparatus by a wire or wirelessly. The device for providing a program may include: a memory for storing a program including instructions which cause the display apparatus to perform a previously-set control method of the display apparatus, information required for the control method of the display apparatus, and the like; a communication unit for performing wired or wireless communication with the display apparatus; and a controller for performing a control operation so as to transmit the relevant program to the display apparatus, at a request from the display apparatus or automatically.

The display apparatus and the control method thereof according to various embodiments of the present invention display an image arrangement condition list, so as to enable a quick search for an image. Also, various image arrangement conditions enable more multilateral image arrangements. The user can designate a particular index in the image arrangement condition list, and thereby can quickly identify an image corresponding to the particular index.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

While the present invention has been shown and described with reference to certain embodiments thereof, it will be understood by those skilled in the art that various changes in form and details may be made therein without departing from the spirit and scope of the present invention as defined by the appended claims and equivalents thereof.

What is claimed is:

1. A control method of a display apparatus that displays at least one image, the control method comprising:
storing the at least one image;
determining an image arrangement condition for arranging the at least one image;
arranging the at least one image and displaying the at least one arranged image, under the image arrangement condition; and
displaying an arrangement condition list including at least one index in the image arrangement condition.

2. The control method as claimed in claim 1, wherein determining the image arrangement condition comprises:
providing a user interface causing at least one image arrangement condition to be selected; and
determining that the image arrangement condition corresponds to a first arrangement condition selected by using the user interface.

3. The control method as claimed in claim 1, wherein determining the image arrangement condition comprises determining that the image arrangement condition corresponds to a second arrangement condition which is set to a default arrangement condition.

4. The control method as claimed in claim 1, wherein arranging the at least one image and displaying the at least one arranged image comprises:
analyzing metadata of the at least one stored image; and
arranging the at least one image and displaying the at least one arranged image, based on the analyzed metadata and the image arrangement condition.

5. The control method as claimed in claim 1, wherein the image arrangement condition comprises at least one of:
a representative color of an image;
a time point when the image has been captured;
a name of a person in the captured image; and
a name of a place where the image has been captured.

6. The control method as claimed in claim 5, wherein the image arrangement condition corresponds to the representative color of the image, and
wherein arranging the at least one image and displaying the at least one arranged image comprises:
determining which color corresponds to a representative color of each of the at least one image; and
arranging the at least one image and displaying the at least one arranged image, under a preset color arrangement condition.

7. The control method as claimed in claim 6, wherein the preset color arrangement condition corresponds to an order of red, orange, yellow, green, blue, indigo, violet and black.

8. The control method as claimed in claim 6, wherein determining which color corresponds to the representative color of each of the at least one image comprises:
acquiring Red, Green and Blue (RGB) values of each pixel in each of the at least one image, and identifying the total number of pixels in each of the at least one image;
generating a histogram vector having a preset number of bins by using the acquired RGB values;
normalizing each of the at least one image by using the identified total number of pixels; and
identifying values of the normalized histogram vector, and determining which color is the representative color.

9. The control method as claimed in claim 8, wherein arranging the at least one image and displaying the at least one arranged image, under the preset color arrangement condition comprises arranging images, which have similar identified values between the normalized histogram vectors of the images, adjacently to each other, and displaying the arranged images.

10. The control method as claimed in claim 5, wherein the image arrangement condition corresponds to the name of the person in the captured image, and
wherein arranging the at least one image and displaying the at least one arranged image comprises:
applying a face recognition algorithm to the at least one image;
matching the person recognized by the face recognition algorithm with pre-stored names; and
arranging the at least one image and the names of the persons in an alphabetical order and displaying the at least one arranged image and the arranged names of the persons, based on a result of the matching.

11. The control method as claimed in claim 10, wherein displaying the arrangement condition list including the at least one index in the image arrangement condition comprises displaying a person name list of the names of the persons.

12. The control method as claimed in claim 5, wherein the image arrangement condition corresponds to the name of the place where the image has been captured, and
wherein arranging the at least one image and displaying the at least one arranged image comprises:
identifying Global Positioning System (GPS) coordinates at the time point when the at least one image has been captured;
matching the identified GPS coordinates with a place name database, and determining the place where the at least one image has been captured; and
arranging the at least one image and the name of the place, where the at least one image has been captured, in an alphabetical order, and displaying the at least one arranged image and the arranged name of the place where the at least one image has been captured.

13. The control method as claimed in claim 12, wherein displaying the arrangement condition list including the at least one index in the image arrangement condition comprises displaying a place name list of the names of the places.

14. The control method as claimed in claim 5, wherein the image arrangement condition corresponds to the time point when the image has been captured, and
wherein arranging the at least one image and displaying the at least one arranged image comprises:
identifying the time point when the at least one image has been captured; and
arranging the at least one image in an order of the time points when the images has been captured, and displaying the at least one arranged image.

15. The control method as claimed in claim 12, wherein displaying the arrangement condition list including the at least one index in the image arrangement condition comprises displaying a time table.

16. The control method as claimed in claim 1, further comprising receiving designation of a first index with respect to the at least one index in the displayed arrangement condition list.

17. The control method as claimed in claim 16, further comprising displaying a first image corresponding to the first index.

18. The control method as claimed in claim 17, wherein displaying the first image comprises displaying the first image and at least one image arranged adjacently to the first image together.

19. The control method as claimed in claim 1, wherein arranging the at least one image and displaying the at least one arranged image comprises arranging the at least one image and displaying the at least one arranged image, downwardly from an uppermost part of a screen of the display apparatus.

20. The control method as claimed in claim 1, wherein arranging the at least one image and displaying the at least one arranged image comprises arranging the at least one image and displaying the at least one arranged image in a form of a spiral, downwardly from an uppermost part of a screen of the display apparatus.

21. A display apparatus comprising:
a storage unit that stores at least one image;
a controller that determines an image arrangement condition for arranging the at least one image; and
a touch screen that arranges the at least one image and displays the at least one arranged image under the image arrangement condition, and displays an arrangement condition list including at least one index in the image arrangement condition.

22. The display apparatus as claimed in claim 21, wherein the controller performs a control operation for displaying a user interface causing at least one image arrangement condition to be selected, and determines that the image arrangement condition corresponds to a first arrangement condition selected by using the user interface.

23. The display apparatus as claimed in claim 21, wherein the controller determines that the image arrangement condition corresponds to a second arrangement condition which is set to a default arrangement condition.

24. The display apparatus as claimed in claim 21, wherein the controller analyzes metadata of the at least one stored image, and controls the touch screen to arrange the at least one image and display the at least one arranged image based on the analyzed metadata and the image arrangement condition.

25. The display apparatus as claimed in claim 21, wherein the image arrangement condition comprises at least one of:
a representative color of an image;
a time point when the image has been captured;
a name of a person in the captured image; and
a name of a place where the image has been captured.

26. The display apparatus as claimed in claim 25, wherein the image arrangement condition corresponds to the representative color of the image, and wherein the controller determines which color corresponds to a representative color of each of the at least one image, and controls the touch screen to arrange the at least one image and display the at least one arranged image under a preset color arrangement condition.

27. The display apparatus as claimed in claim 26, wherein the preset color arrangement condition corresponds to an order of red, orange, yellow, green, blue, indigo, violet and black.

28. The display apparatus as claimed in claim 26, wherein the controller acquires Red, Green and Blue (RGB) values of each pixel in each of the at least one image, identifies the total number of pixels in each of the at least one image, generates a histogram vector having a preset number of bins by using the acquired RGB values, normalizes each of the at least one image by using the identified total number of pixels, and identifies values of the normalized histogram vector and determines which color is the representative color.

29. The display apparatus as claimed in claim 28, wherein the controller controls the touch screen to arrange images, which have similar identified values between the normalized histogram vectors of the images, adjacently to each other and display the arranged images.

30. The display apparatus as claimed in claim 25, wherein the image arrangement condition corresponds to the name of the person in the captured image, and wherein the controller applies a face recognition algorithm to the at least one image, matches the person recognized by the face recognition algorithm with pre-stored names, and controls the touch screen to arrange the at least one image and the names of the persons in an alphabetical order and display the at least one arranged image and the arranged names of the persons, based on a result of the matching.

31. The display apparatus as claimed in claim 30, wherein the controller controls the touch screen to display a person name list of the names of the persons as the image arrangement condition.

32. The display apparatus as claimed in claim 25, wherein the image arrangement condition corresponds to the name of the place where the image has been captured, and wherein the controller identifies Global Positioning System (GPS) coordinates at the time point when the at least one image has been captured, matches the identified GPS coordinates with a place name database and determines the place where the at least one image has been captured, and controls the touch screen to arrange the at least one image and the name of the place, where the at least one image has been captured, in an alphabetical order and display the at least one arranged image and the arranged name of the place where the at least one image has been captured.

33. The display apparatus as claimed in claim 32, wherein the controller controls the touch screen to display a place name list of the names of the places as the image arrangement condition.

34. The display apparatus as claimed in claim 25, wherein the image arrangement condition corresponds to the time point when the image has been captured, and wherein the controller identifies the time point when the at least one image has been captured, and controls the touch screen to arrange the at least one image in an order of the time points, when the images has been captured, and display the at least one arranged image.

35. The display apparatus as claimed in claim 32, wherein the controller controls the touch screen to display a time table as the arrangement condition list in the image arrangement condition.

36. The display apparatus as claimed in claim 21, wherein the touch screen receives designation of a first index with respect to the at least one index in the displayed arrangement condition list.

37. The display apparatus as claimed in claim 36, wherein the controller controls the touch screen to display a first image corresponding to the first index.

38. The display apparatus as claimed in claim 37, wherein the controller controls the touch screen to display the first image and at least one image arranged adjacently to the first image together.

39. The display apparatus as claimed in claim 21, wherein the controller controls the touch screen to arrange the at least one image and display the at least one arranged image, downwardly from an uppermost part of the touch screen.

40. The display apparatus as claimed in claim 21, wherein the controller controls the touch screen to arrange the at least one image and display the at least one arranged image in a form of a spiral, downwardly from an uppermost part of a screen of the display apparatus.
